(19) United States
(12) Patent Application Publication
(10) Pub. No.: US 2026/0357834 A1
(43) Pub. Date: Nov. 12, 2026

(54) SPLIT TYPE FIXING DEVICE

(71) Applicant: HANWIT PRECISION INDUSTRIES LTD., New Taipei (TW)

(72) Inventors: Ying-Chih TSENG, New Taipei (TW); Ming-De WU, New Taipei (TW)

(21) Appl. No.: 19/203,301

(22) Filed: May 9, 2025

(51) Int. Cl. F16B 5/00; F16B 5/04

(52) U.S. Cl. CPC F16B 5/0084; F16B 5/0024; F16B 5/04

(57) ABSTRACT

A split type fixing device includes a positioning column having a column body, a receiving chamber recessed on the bottom of the column body, a riveting portion formed on the outer edge of the receiving chamber and a receiving groove recessed on one side of the column body, a base having a base portion in a disc shape, a first impact portion with a smaller diameter protruding upward from the base portion and forming a fixed structure by punching the riveting portion and a second impact portion with a larger diameter formed downward from the base portion, and an elastic member and an abutment member both received in the receiving groove of the positioning column with the abutment member supported and pushed by the elastic member to partially expose from the receiving groove.

### BACKGROUND OF THE INVENTION

### 1. Field of the Invention

The present invention relates to fixing devices, especially a split type fixing device of which the metal positioning column and the metal base are made separately by CNC lathe, which can greatly reduce the turning time compared with the integrated fixing device, and has the advantages of saving manufacturing time and cost. Furthermore, the base can be made of metal materials of different hardness according to the required hardness of the riveted metal plate, so as to achieve the optimal riveting effect.

### 2. Description of the Related Art

With the rapid development of industrial technology, various industrial products such as computers, televisions, telephones, refrigerators, washing machines, wardrobes, drawers or desks have long become indispensable items in people's lives. The aforementioned industrial products are mostly composed of multiple components, such as the computer housing, the circuit board and heat sink inside the TV housing, the desk panel and supporting side panels, etc., and most of the components are assembled together by locking with screws. The industrial product can be disassembled into multiple components for easy transportation, and then the assembled industrial product can be partially disassembled for maintenance or replacement.

Furthermore, since the components of the aforementioned industrial products are assembled and combined with each other by means of screw locking, when assembling the components of the industrial products, the components whose surfaces are pressed by the heads of the screws are often damaged by being screwed too tightly, such as being dented or broken. In order to solve the aforementioned problem of component damage caused by screw locking, some manufacturers also use welding to assemble the components. However, this design will make it difficult to disassemble some components of the assembled industrial product, thereby causing difficulties in repairing or replacing components.

Therefore, how to solve the various problems caused by the assembly methods of the components of the aforementioned industrial products is the direction that the relevant manufacturers engaged in this industry are eager to study and improve.

### SUMMARY OF THE INVENTION

Therefore, in view of the above problems and deficiencies, the inventor collected relevant information and, after multiple evaluations and considerations, designed the invention of this split type fixing device.

The main object of the present invention is to provide a split type fixing device, which comprises a positioning column comprising a column body, a receiving chamber recessed on the bottom of the column body, a riveting portion formed on the outer edge of the receiving chamber and a receiving groove recessed on one side of the column body, a base comprising a base portion in a disc shape, a first impact portion with a relatively smaller diameter protruding upward from the base portion and forming a fixed structure by punching the riveting portion and a second impact portion with a relatively larger diameter formed downward from the base portion, and an elastic member and an abutment member both received in the receiving groove of the positioning column with the abutment member supported and pushed by the elastic member to partially expose from the receiving groove. As described above, the metal positioning column and the metal base are manufactured separately through CNC lathes, which can significantly reduce the turning time compared to an integrated fixture, thereby having the advantage of saving manufacturing time and cost. Furthermore, the base can be made of metal materials of different hardness according to the required hardness of the riveted metal plate, so as to achieve the optimal riveting bonding effect.

Another object of the present invention is to arrange the receiving chamber and the receiving groove of the positioning column at a perpendicular angle to each other; the receiving groove of the positioning column has an outer edge thereof extended inward by punching to form a stop edge, and the stop edge is used to limit the abutment member so that the abutment member is partially exposed from the receiving groove; the positioning column is cylindrical and a narrow portion is formed by cutting below the outer edge of the column body.

Still another object of the present invention is that the base further comprises a head portion with a relatively smaller diameter protruding upward from the first impact portion, a concave neck portion formed between the head portion and the first impact portion, and an engagement groove formed between the base portion and the second impact portion. And the material cut by the punching of the positioning column is filled up with the neck portion to form a riveted fixation.

Still another object of the present invention is that the second impact portion of the base is used to be riveted into a first through hole of a preset first plate member by punching, and the material of the preset first plate member cut by punching is filled in the engagement groove to form a riveted fixation.

Still another object of the present invention is that the column body of the positioning column is extended into a second through hole of a preset second plate member that is processed to form a convex ring portion around the second through hole and a contact surface on the top side of the convex ring portion, and the abutment member disposed in the receiving groove of the positioning column extends out to contact the contact surface to form a snap-fit fixation.

### BRIEF DESCRIPTION OF THE DRAWINGS

FIG. 1 is a three-dimensional external view of the split type fixing device of the present invention.

FIG. 2 is a three-dimensional external view of the split type fixing device of the present invention from another viewing angle.

FIG. 3 is a three-dimensional exploded view of the split type fixing device of the present invention.

FIG. 4 is a three-dimensional exploded view of the fixing device of the present invention from another viewing angle.’

FIG. 5 is a schematic diagram of the first action of the split type fixing device of the present invention for fixing two plate members.

FIG. 6 is a schematic diagram of the second action of the split type fixing device of the present invention for fixing two plate members.

### DETAILED DESCRIPTION OF+ THE PREFERRED EMBODIMENT

In order to achieve the above-mentioned objects and effect, the technical means and structure adopted by the present invention are described in detail with reference to the preferred embodiment of the present invention, and its features and functions are as follows for a complete understanding.

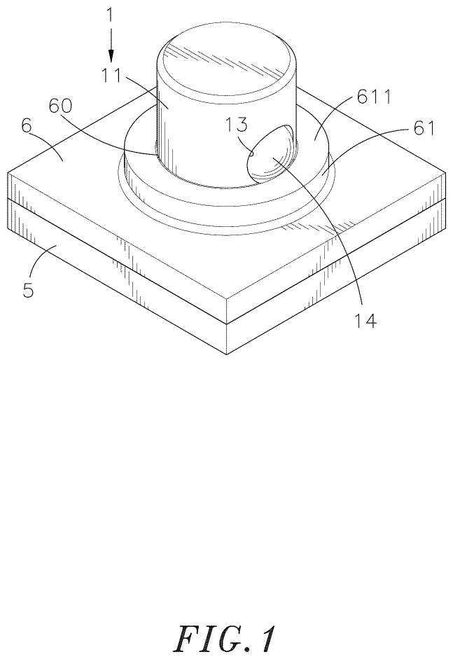

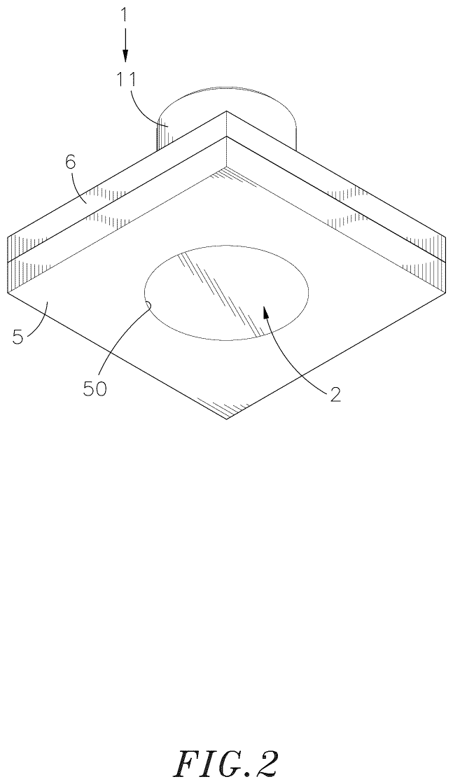

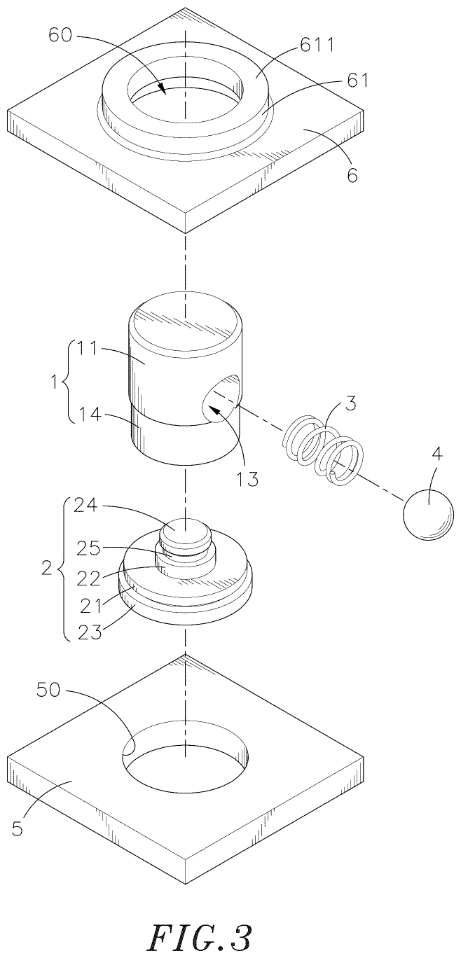

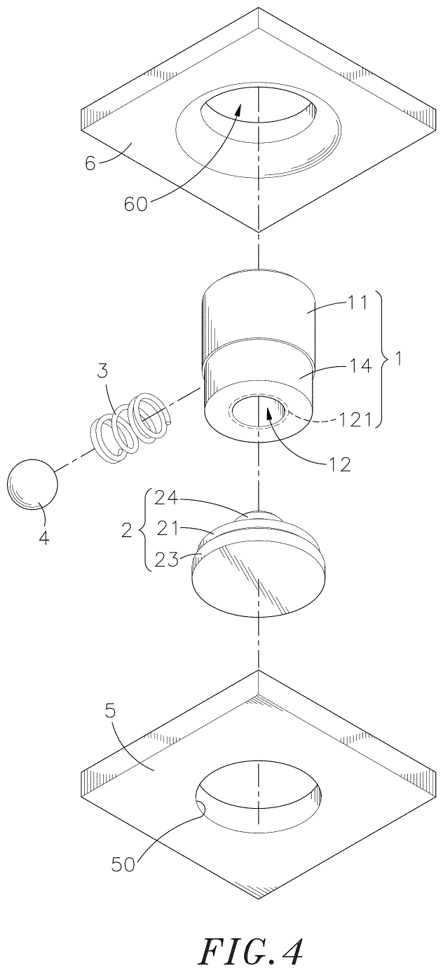

Please refer to FIGS. 1-6, which are three-dimensional external view of the split type fixing device of the present invention, another three-dimensional external view of the split type fixing device of the present invention, three-dimensional exploded view of the split type fixing device of the present invention, another three-dimensional exploded view of the split type fixing device of the present invention, schematic diagram of the first action of the split type fixing device for fixing two plate members and schematic diagram of the second action of the split type fixing device of the present invention for fixing two plate members. As can be clearly seen from the figures, the split type fixing device of the present invention mainly comprises a positioning column 1, a base 2, an elastic member 3 and an abutment member 4, and its main components and features are described in detail as follows:

The positioning column 1 comprises a column body 11, a receiving chamber 12 recessed on the bottom side of the column body 11, a riveting portion 121 formed on the outer edge of the receiving chamber 12, and a receiving groove 13 recessed on the one side of the column body 11.

The base 2 comprises a base portion 21 in a disc shape, a first impact portion 22 with a smaller diameter protruding upward from the base portion 21 and forming a fixed structure by punching the riveting portion 121, and a second impact portion 23 with a larger diameter formed downward from the base portion 21.

The elastic member 3 and the abutment member 4 are both received in the receiving groove 13 of the positioning column 1, and a portion of the abutment member 4 supported and pushed by the elastic member 3 is exposed from the receiving groove 13.

The receiving chamber 12 and the receiving groove 13 of the positioning column 1 are arranged at a perpendicular angle to each other. The outer edge of the receiving groove 13 of the positioning column 1 is extended inward by punching to form a stop edge 131, and the stop edge 131 is used to limit the abutment member 4 so that it is partially exposed from the receiving groove 13. The column body 11 of the positioning column 1 is a cylindrical column body with the lower side of the outer edge thereof cut a narrow portion 14. The narrow portion 14 can be provided to reduce the diameter of the second impact portion 23 to meet product requirements.

The first impact portion 22 of the base 2 is provided with a head portion 24 with a smaller diameter protruding upward, and a concave neck portion 25 is formed between the head portion 24 and the first impact portion 22. The material of the positioning column 1 cut by the punching pressure is filled up with the neck portion 25 to form a riveted fixation. A recessed engagement groove 26 is formed between the base portion 21 of the base 2 and the second impact portion 23. The second impact portion 23 of the base 2 is used to be riveted into a first through hole 50 of a preset first plate member 5 by punching, and the material of the preset first plate member 5 cut by punching is filled in the engagement groove 26 to form riveting fixation.

The column body 11 of the positioning column 1 can extend into a second through hole 60 of a preset second plate member 6. The preset second plate member 6 is processed to form a convex ring portion 61 around the second through hole 60, and a contact surface 611 is formed on the top side of the convex ring portion 61. The abutment member 4 disposed in the receiving groove 13 of the positioning column 1 extends out to contact the contact surface 611 to form a snap-fit fixation. By increasing the distance between the convex ring portion 61 of the second plate member 6 and the first plate member 5, the resistance to separation of the first plate member 5 and the second plate member 6 can be increased, thereby forming a more stable plate fixing structure.

The positioning column 1 and base 2 are both made of metal material, preferably stainless steel, and the hardness of the base 2 is greater than that of the positioning column 1 to facilitate the stability of the two when riveted. The elastic member 3 is formed by a spring; and the abutment member 4 is formed by a metal sphere, but the abutment member 4 is not limited to a spherical configuration, and may also be cylindrical or elliptical.

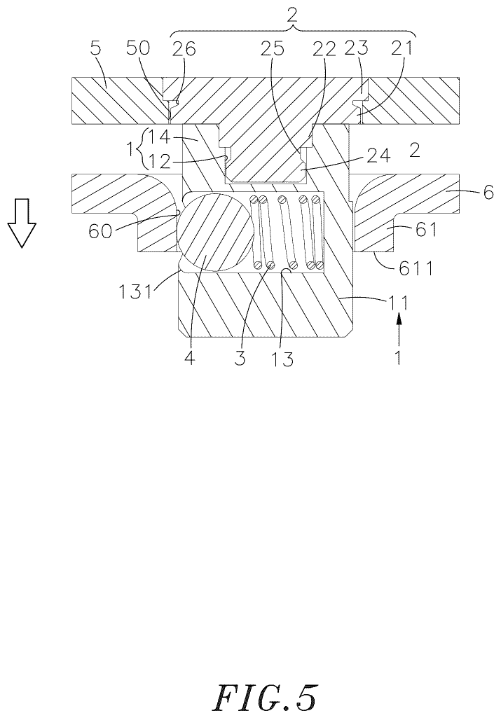

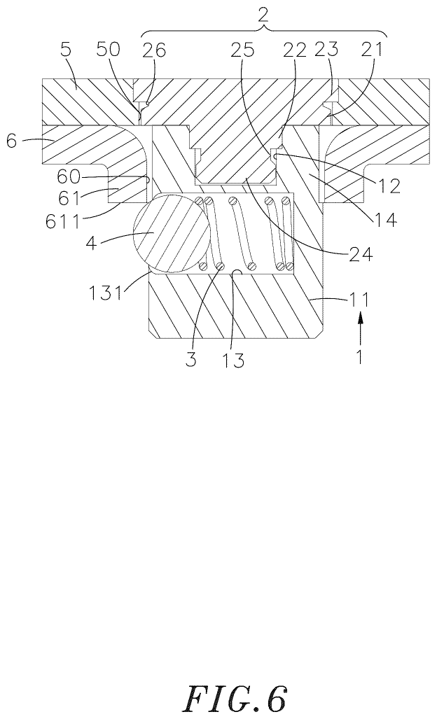

Please refer to FIGS. 5 and 6. When the split type fixing device of the present invention is actually assembled and used, the head portion 24 of the base 2 is first inserted into the receiving chamber 12 of the positioning column 1, and then the bottom side of the base 2 is pressed by a preset pressing fixture (not shown). so that the first impact portion 22 impacts the riveting portion 121 of the positioning column 1. The material cut from the riveting portion 121 of the positioning column 1 after the punching and pressing is filled up with the neck portion 25 to form a riveting structure, so that the positioning column 1 and the base 2 are fixed by riveting. Then, the elastic member 3 and the abutment member 4 are inserted into the receiving groove 13 of the positioning column 1. The outer edge of the receiving groove 13 of the positioning column 1 is then punched with a preset punching jig to form a stop edge 131, and the abutment member 4 is partially exposed from the receiving groove 13 through the limitation of the stop edge 131, so as to complete the overall assembly of the split type fixing device.

Based on the above, the second impact portions 23 of the bases 2 of a plurality of split type fixing devices are riveted downwardly on the first plate member 5 (e.g., the cover plate on the server chassis) at the respective first through holes 50, and the material of the first plate member 5 cut by the punching at the periphery of each first through hole 50 is filled in the engagement groove 26 of the base 2 of each split type fixing device to form a riveted fixation, thereby completing the riveted fixation of the first plate member 5 and the split type fixing devices. Then extend the column bodies 11 of positioning columns 1 downward into the respective second through holes 60 of the second plate member 6 (e.g. the side plate of the server chassis). The abutment members 4 located on the side of the respective positioning columns 1 are squeezed by the inner walls of the respective convex ring portions 61 to form an inward contraction and the respective elastic members 3 are compressed. When the abutment members 4 are located at the contact surfaces 611 of the respective convex ring portions 61, there is no interference with any mechanism, so the elastic members 3 are elastically reset to push the respective abutment members 4 out to contact the respective contact surfaces 611 to form a locking and fixing. By slightly pushing the second plate member 6 toward the first plate member 5, the user can feel the contact between the abutment member 4 and the contact surface 611, and can clearly know that the first plate member 5 and the second plate member 6 have been combined and firmly fixed (for example, the cover is fastened to the server chassis), so as to achieve the purpose of simple and intuitive operation and firmly fixed position.

The main feature of the present invention is that the metal positioning column 1 and the metal base 2 are separately manufactured by a computer numerical control (CNC) lathe, which can significantly reduce the turning time compared with an integrated fixing device, thereby saving manufacturing time and cost. Furthermore, the base 2 can be made of metal materials of different hardness according to the required hardness of the metal plate to be riveted, so as to achieve the optimal riveting effect.

The above is only a preferred embodiment of the present invention, and does not limit the patent scope of the present invention. Therefore, all simple modifications and equivalent structural changes made by using the contents of the description and drawings of the present invention should be included in the patent scope of the present invention and should be declared.

In summary, the split type fixing device of the present invention can achieve its effect and purpose when used. Therefore, this invention is truly an invention with excellent practicality. In order to meet the application requirements for invention patents, we have filed an application in accordance with the law. We hope that the review committee will approve this case as soon as possible to protect the inventor's hard work in research and development. If the review committee has any questions, please feel free to write to us for instructions. The inventor will do his best to cooperate and we will be very grateful.

What the invention claimed is:

1. A split type fixing device, comprising:
a positioning column comprising a column body, a receiving chamber recessed on a bottom side of said column body, a riveting portion formed on an outer edge of said receiving chamber, and a receiving groove recessed on one side of said column body;
a base comprising a base portion in a disc shape, a first impact portion with a relatively smaller diameter protruding upward from said base portion and forming a fixed structure by punching said riveting portion, and a second impact portion with a relatively larger diameter formed downward from said base portion; and
an elastic member and an abutment member both received in said receiving groove of said positioning column, said abutment member being supported and pushed by said elastic member to partially expose from said receiving groove.

2. The split type fixing device as claimed in claim 1, wherein said receiving chamber and said receiving groove of said positioning column are arranged at a perpendicular angle to each other.

3. The split type fixing device as claimed in claim 1, wherein said receiving groove of said positioning column has an outer edge thereof extended inward by punching to form a stop edge, and said stop edge is used to limit said abutment member so that said abutment member is partially exposed from said receiving groove.

4. The split type fixing device as claimed in claim 1, wherein said column body of said positioning column is a cylindrical column body with a lower side of an outer edge thereof cut below to form a narrow portion.

5. The split type fixing device as claimed in claim 1, wherein said base further comprises a head portion with a relatively smaller diameter protruding upward from said first impact portion, and a concave neck portion formed between said head portion and said first impact portion; the material cut by the punching of said positioning column is filled up with said neck portion to form a riveted fixation.

6. The split type fixing device as claimed in claim 1, wherein said base further comprises an engagement groove formed between said base portion and said second impact portion.

7. The split type fixing device as claimed in claim 1, wherein said second impact portion of said base is used to be riveted into a first through hole of a preset first plate member by punching, and the material of said preset first plate member cut by punching is filled in an engagement groove to form a riveted fixation.

8. The split type fixing device as claimed in claim 1, wherein said column body of said positioning column is extended into a second through hole of a preset second plate member that is processed to form a convex ring portion around said second through hole and a contact surface on a top side of said convex ring portion, and said abutment member disposed in said receiving groove of said positioning column extends out to contact said contact surface to form a snap-fit fixation.

9. The split type fixing device as claimed in claim 1, wherein said positioning column and said base are both made of metal material, preferably stainless steel, and said base is harder than said positioning column.

10. The split type fixing device as claimed in claim 1, wherein said elastic member is formed of a spring; and said abutment member is formed of a metal sphere.
